(19) United States
(12) Patent Application Publication
(10) Pub. No.: US 2024/0400868 A1
(43) Pub. Date: Dec. 5, 2024

(54) ADHESIVE ARTICLE WITH RECYCLABLE OR COMPOSTABLE RELEASE LINER

(71) Applicant: 3M INNOVATIVE PROPERTIES COMPANY, St. Paul, MN (US)

(72) Inventors: Guy M. Kallman, Woodbury, MN (US); Ignatius A. Kadoma, Cottage Grove, MN (US); Rohit Gupta, St. Paul, MN (US); Karl E. Benson, St. Paul, MN (US); Sara Hemmer Frisco, Blaine, MN (US); Michelle Ji, Woodbury, MN (US)

(21) Appl. No.: 18/697,120

(22) PCT Filed: Oct. 17, 2022
(86) PCT No.: PCT/IB2022/059961

§ 371 Date: Mar. 29, 2024

Related U.S. Application Data
(60) Provisional application No. 63/257,948, filed on Oct. 20, 2021.

(51) Int. Cl. C09J 7/40

(52) U.S. Cl. CPC C09J 7/401; C09J 7/403; C09J 7/405; C09J 2301/16; C09J 2400/283; C09J 2467/005; C09J 2469/006; C09J 2483/005; C09J 2491/005

(57) ABSTRACT

An adhesive article attachable to a substrate may include an adhesive layer attachable to a major surface of a substrate and a releasable liner in contact with the adhesive layer. The releasable liner has a release layer and a biodegradable polymer layer applied to the release layer. The release layer defines a structured surface in contact with the adhesive layer.

Adhesives articles are useful, among other uses, to adhere a desired article to a substrate. Release liners are used to protect the adhesiveness of the adhesive itself. These liners can be released easily by a user before use.

### SUMMARY

In one aspect, an adhesive article attachable to a substrate includes an adhesive layer attachable to a major surface of a substrate and a releasable liner in contact with the adhesive layer. The releasable liner has a release layer and a biodegradable polymer layer applied to the release layer. The release layer defines a structured surface in contact with the adhesive layer.

In another aspect, a method of forming an adhesive article includes providing an adhesive layer and laminating a releasable liner to the adhesive layer. The releasable liner includes a release layer and a biodegradable polymer layer applied to the release layer. The release layer defines a structured surface in contact with the adhesive layer.

### BRIEF DESCRIPTION OF DRAWINGS

FIG. 1 is a side elevation schematic cross-section of an adhesive article.

FIG. 2 is a side elevation schematic cross-section of a releasable liner.

FIG. 3 is a side elevation schematic of a method of forming an adhesive article.

FIG. 4 is a side elevation schematic of another method of forming an adhesive article.

FIG. 5 is a side elevation schematic cross-section of a tape-type adhesive article.

### DETAILED DESCRIPTION

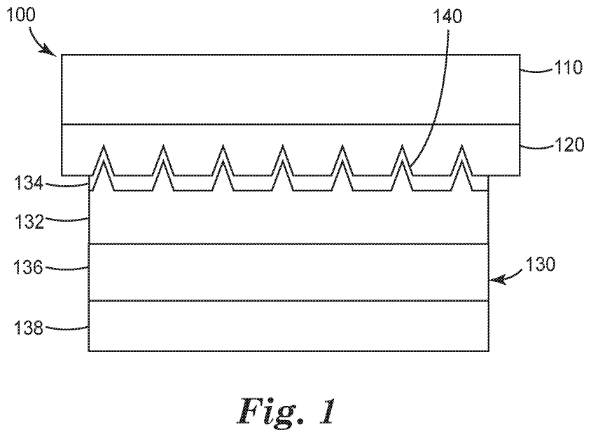

FIG. 1 is a side elevation schematic cross-section of an adhesive article. Adhesive article 100 includes substrate 110, adhesive layer 120 attached to substrate 110, and releasable liner 130 applied to adhesive layer 120. In some embodiments, substrate 110 is optional. In some embodiments, an adhesive article including adhesive layer 120 and releasable liner 130 without substrate 110 may provide a single-liner adhesive transfer tape. In some embodiments, the adhesive article may include one, two, or more of a substrate, an adhesive layer, and a releasable liner.

Adhesive article 100 adhesive article may include any suitable substrate. In some embodiments, the substrate 110 may be or include a polymeric material. In some embodiments, substrate 110 may be another liner, which may provide a double-liner adhesive transfer tape.

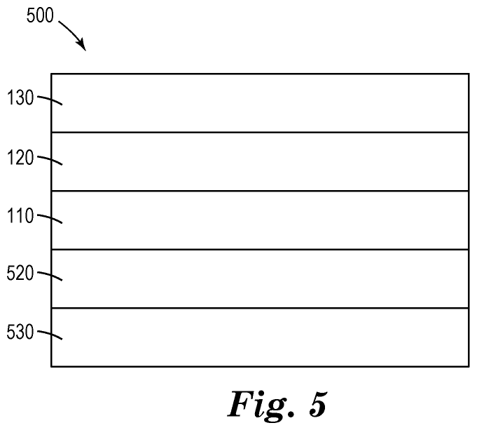

In some embodiments, substrate 110 may be a backing layer or a core, which may include a polymeric foam material, to provide a double-sided adhesive tape (see FIG. 5). Suitable polymeric materials include polyethylene terephthalate (PET), high- or low-density polyethylene or polyesters generally, polycarbonate, polyvinyl chloride (PVC), polystyrene, polylactic acid (PLA), or cellulose acetate. Other suitable materials include paper or wood pulp materials, nonwoven or woven webs of natural or synthetic fibers.

Suitable polymeric foam materials may include a polycarbonate, a polyacrylic, a polymethacrylic, an elastomer, a styrenic block copolymer, a styrene-isoprene-styrene (SIS), a styrene-ethylene/butylene-styrene block copolymer (SEBS), a polybutadiene, a polyisoprene, a polychloroprene, a random copolymer of styrene and diene styrene-butadiene rubber (SBR), a block copolymer of styrene and diene styrene-butadiene rubber (SBR), an ethylene-propylene-diene monomer rubber, a natural rubber, an ethylene propylene rubber, a polyethylene-terephthalate (PET), a polystyrene-polyethylene copolymer, a polyvinylcyclohexane, a polyacrylonitrile, a polyvinyl chloride, a polyurethane, an aromatic epoxy, an amorphous polyester, amorphous polyamides, a semicrystalline polyamide, an acrylonitrile-butadiene-styrene (ABS) copolymer, an ethylene-vinyl acetate (EVA), the copolymers of ethylene and vinyl acetate: also referred to as polyethylene-vinyl acetate (PEVA), a low-density polyethylene (LDPE), a polypropylene (PP), including expanded polypropylene (EPP) and polypropylene paper (PPP), a polystyrene (PS), including expanded polystyrene (EPS), extruded polystyrene (XPS) and sometimes polystyrene paper (PSP), a nitrile rubber (NBR) as in the copolymers of acrylonitrile (ACN) and butadiene, a polyphenylene oxide alloy, a high impact polystyrene, a polystyrene copolymer, a polymethylmethacrylate (PMMA), a fluorinated elastomer, a polydimethyl siloxane, a polyimide, a polyetherimide, an amorphous fluoropolymer, an amorphous polyolefin, a polyphenylene oxide, a polyphenylene oxide-polystyrene alloy, or mixtures thereof. The foam may be formed as a coextruded sheet with the adhesive on one or both sides of the foam, or the adhesive may be laminated to it. When the adhesive is laminated to a foam, it may be desirable to treat the surface to improve the adhesion of the adhesive to the foam or to any of the other types of backings. Such treatments are typically selected based on the nature of the materials of the adhesive and of the foam or backing and include primers and surface modifications (e.g., corona treatment, surface abrasion). Additional foam tape constructions may include those described in U.S. Pat. No. 5,602,221 (Bennett et al.), U.S. Pat. No. 4,223,067 (Levens), and U.S. Pat. No. 6,103,152 (Gehlsen et al.), which are incorporated herein by reference.

Substrate 110 may be substantially transparent, may have a high degree of diffusion (e.g., exhibit high haze and/or low clarity), or may include one or more pigments or colorants rendering it translucent or even opaque.

Substrate 110 may be printed or printable. Adhesive article 100 may include an ink layer applied to a side of, or embedded in, substrate 110. In some embodiments, adhesive layer 120 may be applied to a major surface of substrate 110, and the ink layer may be on a major surface of substrate 110 opposite adhesive layer 120.

Substrate 110 may be formed to be any suitable size, shape, or thickness, through any appropriate process. In some embodiments, substrate 110 may be formed through a melt extrusion or a blown extrusion process. In some embodiments, substrate 110 may be formed through a calendaring process. In some embodiments, substrate 110 may be formed through a casting (e.g., a solvent casting) process. In some embodiments, substrate 110 may be formed from an additive manufacturing process.

In some embodiments, where the adhesive article is tape- or film-like, substrate 110 may be from 10 micrometers to 3000 micrometers thick. In some embodiments, substrate 110 may be a portion of a larger material or surface. In some embodiments, substrate 110 may be several millimeters, centimeters, or even meters thick. For example, substrate 110 may be a portion of a floor, wall, or ceiling. Substrate 110 may be a portion of any object (vehicle, wall, box, electronic device), so long as, for example, the adhesive selected is able to adhere to the surface of the substrate.

Adhesive layer 120 may be any suitable material and may formed through any suitable process. In some embodiments, adhesive layer 120 includes an epoxy or an optically clear adhesive. In some embodiments, adhesive layer 120 is or includes a pressure sensitive adhesive layer. In some embodiments, adhesive layer 120 is or includes an acrylic pressure sensitive adhesive layer. In some embodiments, adhesive layer 120 is formed through a solvent coating process. In some embodiments, adhesive layer 120 is formed through an extrusion (melt- or blown-) process. Adhesive layer 120 may have any suitable thickness. Adhesive layer 120 may be selected for its rheological or optical properties. The adhesive layer may include a pigment, dye, or other colorant. In some embodiments, the adhesive may be between 10 and 1550 micrometers thick. In some embodiments, the adhesive may include partially embedded microbeads, made from materials such as glass, ceramic, or polymeric resin or agglomerations thereof held together with a suitable binder material. In some embodiments, such microbeads may be index matched to the index of the adhesive layer.

In some embodiments, especially if the substrate does not inherently bond well to the adhesive chemistry, some embodiments may optionally include a prime layer on the substrate. The prime layer, also often called a primer or tie layer, may be any suitable substance or composition with any suitable thickness. The selection of the prime layer is to ensure sufficient adhesion (to prevent ply-bond failure) between the substrate and the adhesive layer, and to bond to both. In some embodiments, the prime layer may include a polyamide or a copolyamide. Certain materials may be alternatively or additionally useful as a barrier layer to prevent the migration of plasticizer, water, solvent, or other contaminants from the side of the substrate opposite the adhesive layer into the adhesive layer. Such a prime layer may be extremely thin: for example, less than 10 micrometers thick, less than 6 micrometers thick, less than 5 micrometers thick, less than 4 micrometers thick, less than 3 micrometers, thick, less than 2 micrometers thick, or even less than 1 micrometer thick. Such layers may be solvent cast, coated, or even extruded or coextruded (with one or more of the other layers).

Releasable liner 130 is disposed on and in contact with adhesive layer 120 and is intended to protect the exposable (and adherable) side of the adhesive layer before it is attached to its ultimate surface. Accordingly, such a releasable liner is peelable and removable by a user at or near the time of installation. Installation may include laminating the adhesive article (without the releasable liner) to another film or film stack.

Releasable liner 130 may be constructed to be easily peelable, but also adapted to maintain contact with the adhesive layer until the time of removal. In some embodiments, the average peel force required to remove the releasable liner 130 from the adhesive layer 120 is less than or equal to 1000, 800, 500, 200, 150, 135, 100, 50, 30, or even 10 g/in.

This peel force may not only be affected by the material, but also by any physical structure present on the adhesive-interfacing surface of the release liner (described in more detail below), and also by environmental aging (e.g., prolonged exposure to temperature and humidity). The shockiness of the peel may also be an important parameter in some applications. A low variation in peel force corresponds to a smoother (less shocky) peel. In some embodiments, the root-mean-square deviation from the average peel force is less than or equal to 200, 100, 50, 20, 10, 5, or even 1 g/in.

Releasable liner 130 may be formed from any suitable materials. Silicone and other existing release materials are not easily recyclable in many commercial recycling streams. However, many recyclable materials alone provide an unacceptably high (or shocky) peel. A combination of a biodegradable polymer layer and a relatively thin release layer, which may be non-biodegradable material, may provide sufficient releasability and compostability or recyclability for the releasable liner 130.

Releasable liner 130 includes more than one layer. As illustrated in FIG. 1, releasable liner 130 includes two layers, release layer 132 and biodegradable polymer layer 134 applied to release layer 132. As used herein, the term “biodegradable” refers to a material that decomposes, or degrades, in the environment, for example, due to exposure to bacteria or other living organisms.

In some embodiments, the releasable liner 130 may be compostable. In particular, the biodegradable polymer layer 134 may be made of a compostable material. As used herein, the term “compostable” refers to materials, compositions, or articles that meet the standard ASTM D6400 or ASTM D6868. It should be noted that those two standards are applicable to different types of materials, so the material, composition, or article need only meet one of them, usually whichever is most applicable, to be “compostable” as defined herein. Particularly, compostable materials, compositions, or articles will also meet the ASTMD5338 standard. Particularly, compostable materials, compositions, or articles will also meet one or more of the EN 12432, AS 4736, or ISO 17088 standards. More particularly, compostable materials, compositions, or articles will also meet the ISO 14855 standard.

The term “compostable” as used herein is not the same as the term “biodegradable.” Something that is “compostable” must degrade within the time specified by the above standard or standards into materials having a toxicity, particularly plant toxicity, that conform with the above standard or standards. The term “biodegradable” does not specify the time in which a material must degrade nor does it specify that the compounds into which it degrades pass any standard for toxicity or lack of harm to the environment. For example, materials that meet the ASTM D6400 standard must pass the test specified in ISO 17088, which addresses “the presence of high levels of regulated metals and other harmful components,” whereas a material that is “biodegradable” may have any level of harmful components. In some embodiments, the release liner 130 may still be compostable while including less than 0.5%, or even less than 1%, material that is unrecoverable or non-biodegradable.

Because biodegradable polymer layer 132 is not in contact with the adhesive layer 120, biodegradable polymer layer 132 may be selected for properties other than its surface energy (i.e., its releasability from a particular adhesive layer). In some embodiments, biodegradable polymer layer 132 may be or include a polymeric material that is commercially recyclable or a bioplastic.

Non-limiting examples of suitable materials used in the biodegradable polymer layer 134 include: polybutylene succinate (PBS), poly(lactic acid) (which is sometimes known as PLA, and as used herein is intended to encompass both poly(lactic acid) and poly(lactide)), poly(glycolic acid) (which as used herein is intended to encompass both poly(glycolic acid) and poly(glycolide)), poly(caprolactone), poly(lactide-co-glycolide), copolymers of two or more of lactic acid, glycolic acid, and caprolactone, polyhydroxyalkanoate (PHA), polyester urethane, degradable aliphatic-aromatic copolymers, poly(hydroxybutyrate) (PHB), copolymers of hydroxybutyrate and hydroxy valerate, poly(ester amide), polyhydroxy hexanoate (PHH), cellulosic ester, and cellulose.

In some embodiments, the releasable liner 130 may be recyclable. As used herein, the term “recyclable” refers to voluntary or local guidelines on materials that are acceptable. Under some guidelines, “recyclable” refers to a liner that has less than 15% material that is nonrecoverable for recycling. The releasable liner 130 may contain less than 15% of a non-biodegradable material.

Releasable liner 130 may include polybutylene succinate (PBS), for example, in the biodegradable polymer layer 134. PBS is a biodegradable and compostable thermoplastic aliphatic polyester that decomposes naturally into water and carbon dioxide in the presence of microorganisms such as, for example, Amycolatopsis sp. HT-6 and Penicillium sp. Strain 14-3. PBS has a lower melting point (115° C.) than other biodegradable bioplastics such as polylactic acid (PLA), making it more easily extrudable.

In some embodiments, PBS and a small amount of a wax (particularly a plant-based wax) can provide an acceptable or “premium” release performance while not requiring landfilling of the discarded liner. In some embodiments, releasable liner 130 also includes between 0.5 and 5 polymer weight percent of wax. Suitable waxes include ethylene bis(stearamide) (EBS), castor wax, polyamitic acid, linoleic acid, arachidonic acid, polantolic acid, butyric acid, steric acid, and triglyceride. In some embodiments, the wax is a plant-based wax. Suitable plant-based waxes include castor wax, EBS, and soy wax.

The release layer 132 may be made of or include any suitable material to facilitate releasability, such as PBS, silicone, silicone polyoxamide, or octadecyl carbomyl ethyl acrylate (ODCEA). In some embodiments, the release layer 132 is made of or includes non-biodegradable material, such as silicone. When present in the releasable liner 130, the amount of silicone or other non-biodegradable material may be limited to a maximum percentage to facilitate composting or recycling. In some embodiments, a ratio of a weight of the release layer 132 to a total weight of the releasable liner 130 is less than 15%, which may facilitate recyclability. In some embodiments, a ratio of a weight of the release layer 132 to a total weight of the releasable liner 130 is less than 1%, or even less than 0.5%, which may facilitate compostability.

In some embodiments, release liner 130 may also include a woven or nonwoven material formed from natural fibers. In some embodiments, release liner 130 may include a wood pulp or paper-like material. As illustrated in FIG. 1, release liner 130 includes paper layer 136. The biodegradable polymer layer 132 may be formed on paper layer 136. Any suitable paper material may be used that is biodegradable, compostable, or recyclable.

In some embodiments, release liner 130 may also include another biodegradable polymer layer 138 applied to an opposite side of paper layer 136 than biodegradable polymer layer 132. Some recycling guidelines or standards may prefer only the presence of biodegradable polymer layer 132 and paper layer 136. Some composting guidelines or standards may prefer the addition of biodegradable polymer layer 138 to cover both sides of paper layer 136 with biodegradable polymer.

Adhesive article 100 may be formed using any suitable technique. In some embodiments, a technique for forming adhesive article 100 may include laminating releasable liner 130 to adhesive layer 120.

The technique may also forming releasable liner 130, which may include applying (or coating) release layer 134 onto biodegradable polymer layer 132. Release layer 134 and biodegradable polymer layer 132 may be embossed.

Adhesive article 100 may be used in any suitable manner. For example, adhesive article 100 may be used by removing releasable liner 130 from adhesive layer 120 and laminating adhesive layer 120 onto a surface of an object.

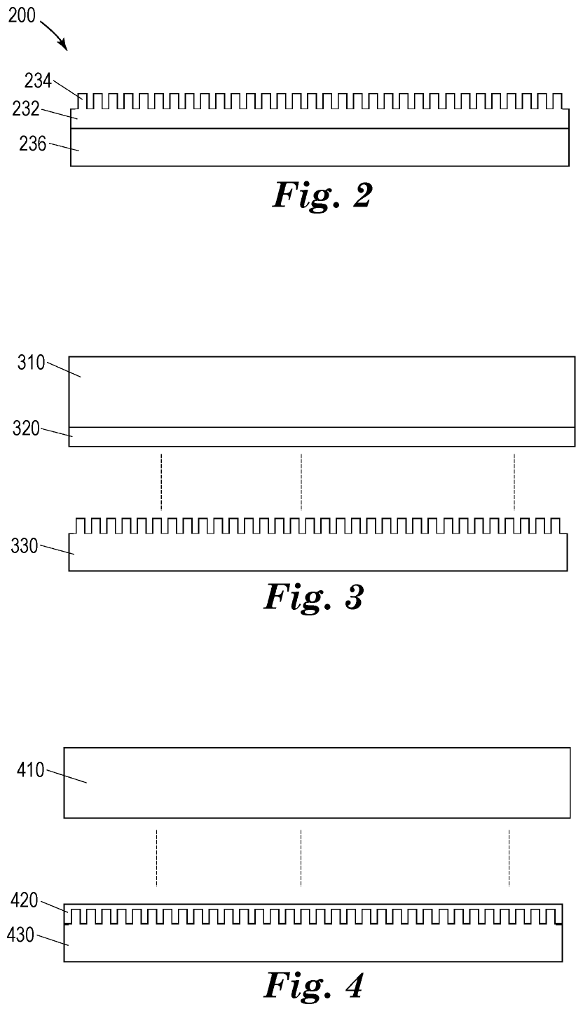

As can be seen in FIG. 1 and FIG. 2, the releasable liner may include a structured surface. FIG. 1 shows releasable liner 130 including structured surface 140. FIG. 2 shows releasable liner 200 including structured surface 234.

FIG. 2 is a side elevation schematic cross-section of a releasable liner 200. Releasable liner 200 includes release layer 232 including structured surface 234. Release layer 232 is optionally disposed on biodegradable polymer layer 236. Although not shown, releasable liner 200 may also include paper layer 136 (FIG. 1) and another biodegradable polymer layer 138 (FIG. 1).

Structured surfaces 140, 234 may include raised features defining the structured surface of the release layer. Structured surfaces 140, 234 disposed on one of the major surfaces of the releasable liner may include any suitable micro- or macro-structure. In some embodiments, structured surfaces 140, 234 includes microstructures to impart airbleed properties, which may be posts, prisms, raised rails, linear rail segments, or any other suitable shape. In some embodiments, at least one dimension of the structures is between 1 and 1000 micrometers. In some embodiments, structured surfaces 140, 234 may include a pseudo-random or rough textured surface, which may impart airbleed properties. In some embodiments, structured surfaces 140, 234 may include an impression filled with beads, which may impart slideability.

Structured surfaces 140, 234 may be formed from any suitable process, including additive manufacturing (e.g., 3D printing), negative manufacturing (e.g., etching), microreplication (e.g., continuous cast and cure), embossing, etc. In some embodiments, one or more of the shape, size, and relative positioning of the microstructures may vary across one or more directions of the releasable liner.

Structured surfaces 140, 234 may significantly affect the peel force needed to strip (or remove or release) the releasable liner. Because of the reduced surface area in contact with the adhesive (for at least certain structure shapes), the required peel force may be significantly reduced (on a per unit length basis).

Structured surfaces 140, 234 may have an alternative or additional benefit. Certain commercially available films include a structured adhesive, with microfeatures that can provide application features such as airbleed and slideability (e.g., IJ180Cv3 from 3M Company, with Comply™ and Controltac™ adhesive). In some cases, these structured features are formed by mating a structured liner to a substantially featureless adhesive layer. The features are embossed—and the adhesive receives a structured pattern that is the inverse of the structured liner. For example, in order to make channels in an adhesive layer, one would mate a structured liner having rails or ridges. However, this structured interface surface may provide even more contact surface area between the liner and the adhesive, and therefore the acceptability of the design may be even more reliant on the selection of the material. Certain selections of the shape and size of the structures—and the thickness and flowability of the adhesive—may help to prevent the adhesive fully wetting out the surface structure, thereby reducing the effect that closely mated structures may have on release. For example, in some embodiments, structures are shaped and sized such that the structure displaces more volume per unit area between the bearing surface and the planar land region than the adhesive volume for that same unit area.

Structured surfaces 140, 234 are formed from or on a respective release layer. Release layer 232 includes the materials described above in connection with release layer 134. Release layer 232 may be formed on biodegradable polymer layer 236. The combination of a very thin release layer 232 and the biodegradable polymer layer 236 may be structured to provide desirable releasability and compostability or recyclability.

FIG. 3 is a side elevation schematic of a method of forming an adhesive article. Substrate 310 with adhesive layer 320 disposed on a major surface is laminated together with releasable liner 330. Such a lamination may be performed in a batch or as a continuous process.

FIG. 4 is a side elevation schematic of another method of forming an adhesive article. Substrate 410 is laminated to releasable liner including adhesive layer 420 coated thereon. Like the process illustrated in FIG. 3, such a process may likewise be done in a batch process or in a continuous (roll-to-roll) process.

FIG. 5 is a side elevation schematic cross-section of adhesive article 500 that is a tape including the releasable liner. As illustrated, adhesive article 500 includes substrate 110 (e.g., as a backing layer), first and second adhesive layers (adhesive layer 120 and adhesive layer 520), and first and second releasable liners (releasable liner 130 and releasable liner 530) to provide a double-sided adhesive tape with double liners. Second releasable liner 530 may be the same as or similar to releasable liner 130 in terms of material or construction.

Substrate 110 may have a first major surface and a second major surface on an opposite side of the substrate. Adhesive layer 120 and adhesive layer 520 may be positioned on opposite surfaces of the substrate 110. Adhesive layer 120 may be positioned in the first major surface. Adhesive layer 520 may be positioned on the second major surface. Releasable liner 130 may be positioned on adhesive layer 120 on the side opposite to substrate 110. Releasable liner 530 may be positioned on adhesive layer 520 on the side opposite to substrate 110.

One of first and second releasable liners 130, 530 may be optional. In some embodiments, adhesive article 500 includes only one of releasable liners 130, 530 to provide a double-sided adhesive tape with a single liner.

Any suitable adhesive article material or construction for a tape, including adhesive transfer tapes or double-sided tapes, may include one or more liners including releasable liner 130 or releasable liner 530, such as those materials and constructions described in WO 2019/193468, published Oct. 10, 2019, which is incorporated herein by reference in its entirety.

Descriptions for elements in figures should be understood to apply equally to corresponding elements in other figures, unless indicated otherwise. The present invention should not be considered limited to the particular embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

### EXAMPLES

Biodegradable releasable liners were prepared and tested. Release properties were measured and are shown in the following examples.

These examples are merely for illustrative purposes only and are not meant to be limiting on the scope of the appended claims. All parts, percentages, ratios, etc. in the examples and the rest of the specification are by weight, unless noted otherwise. The following abbreviations are used herein: um or μm=micrometer, min=minute, in=inch, gms=grams, psi=pounds per square inch, KPa=Kilopascal, kg=kilogram, MW=molecular weight.

TABLE 1
Materials

| Abbreviation | Description |
|---|---|
| PBS | Polybutylene Succinate, BIOPBS FZ71 available from PTT MCC Biochem Co., |
| | Ltd., Bangkok, Thailand |
| S1 | Substrate - Bleached 65# Kraft Paper from Alhstrom, KauKauna, WI |
| RC1 | Release Chemistry 1 - Silicone Polyoxamide. A copolymer of 15,000 MW |
| | silicone and ethylene dioxamide as described in U.S. Pat. Pub. No. |
| | 2007/0149745 A1 (Leir et al.) |
| RC2 | Release Chemistry 2 - Copolymer of ODCEA (Octadecyl Carbomyl Ethyl |
| | Acrylate) with the weight ratio of ODCEA/VAc being 75/25, polymerized in |
| | water to form a stable emulsion at 15% solids. ELAB (41-4207-0825-1), |
| | synthesized at 3M Cottage Grove, MN |
| RC3 | Release Chemistry 3 - Silicone coating with resin, catalyst, and crosslinker |
| | all from Momentive GE. |
| PC | 0.118″ thick Makrolon polycarbonate, provided by Cope Plastics, Alton |
| | IL. |
| IJ180-10 | Available from 3M company, St. Paul MN |
| PCK | Polycoated Kraft Paper with a Polyethylene coating weight of 23 grams/m² on |
| | 64# stay flat paper from Schoeller, company (Germany). Polyethylene |
| | coating by 3M Company, Nevada MO. |

### Test Methods.

### Sample Preparation and Conditioning

Liner Exchange-Tape 10 cm×10 cm Embossed Liner, pattern side up on a 15 cm×15 cm sheet of PC that is 3 mm thick. Cut 3-2.5 cm×15 cm Strips of IJ180-10. Remove the liner and hand squeegee each strip to the taped down liner using moderate pressure, bringing the adhesive side of each into contact with the embossed side of the liner

Sample Conditioning—With the 3 strips face down on the embossed liner (pattern up) taped to the flat PC substrate, put samples under 22.7 Kgf sandbag with a flat portion contact area of 30 cm×40 cm approximating uniform pressure of 190 Kgf/m² on the samples laying between the surface of the sandbag and the supporting PC sheet. Hold for 1 week in constant temperature and humidity room (72° F., 50% RH).

Measure Release Peel Force-Using handheld scale, attach and pull sample at 180 degrees with a speed of 115 cm/min. Record average peel force.

### Adhesive Channel Depth and Liner Ridge Height Measurement

A white light interferometer (available as the ContourGT with VISION64 operating and analysis software from Bruker) was used to assess and report the adhesive groove depth and liner ridge height. Sample topography was acquired using the measure function while using a 10× lens. The following procedure was used to report ridge height and/or groove depth depending on sample type:
1) Use Terms Removal for Curvature and tilt
2) Use Data Restore with iterations at 20
3) On 2D chart setup 2 point poly line and draw profile across channel/ridge
4) Report average of 5 measurements as ridge height and/or channel depth depending on sample type

Liner Ridge Height=Average of liner ridge heights.

Adhesive Grove Depth Same Day as Peel=Average of adhesive groove depths measured the day the film was removed from the liner

Adhesive Grove Depth After Two Weeks=Average adhesive groove depths measured after samples sat open faced (adhesive exposed) for two weeks at room temperature conditions.

### Examples E1-E3 and C1

Examples E1-E3 were made by extruding 45 micrometers of PBS onto SI which was then ran through a cold nip roller. A four-zone single screw extruder was used with increasing temperature profiles of 200° F., 350° F., 450° F., and 500° F. The extruder die temp was 500° F. with an extrusion rate of 600 ft/min. The nip roller temperature was 150° F. The resulting materials were then corona treated to improve PBS to substrate bonding. The resulting film was then gravure coated with RC1, RC2 or RC3 to give E1, E2 and E3 respectively. The target thickness for gravure coating was less than 1 micron. The gravure coated materials were then dried in a forced air oven first at 150° F. for 20 seconds and second at 180° F. for 10 seconds. C1 was a PCK liner. After the samples were prepared, they were subjected to the peel test and structural measurements (Table 2).

### Example E4

Example E4 was made by the process used for E1-E3 using RC3 for coating. A pattern was embossed by the same method disclosed in US 2021/0017426 A1 for generation of example 1. A pattern was embossed into the release liner by passing the release liner between a silicone rubber roll and an engraved metal roll. This pattern was a series of channels that are linear in direction and around 23 microns tall. A pressure sensitive adhesive solution (A1) was slot die coated and dried onto the structured side of the embossed release liner using a continuous coating/dryer line using the same conditions specified in US 2021/0017426 A1 example 1. The adhesive side of the adhesive coated release liner E4 was then laminated at room temperature to film (F1).

TABLE 2
Liner measurements and release results

| | | | | | | Adhesive |
|---|---|---|---|---|---|---|
| | | | | | Adhesive | Groove - |
| | | | | Liner | Groove - | after 2 |
| | | | | Ridge | Same Day | weeks |
| | | Average Peel | | Height | of Peel | open face |
| Sample | Tool | Force (gms) | | (μm) | (μm) | (μm) |
| C1 | x-hatch 13* | <10 | gms | 11.2 | 4.8 | None |
| E1 | x-hatch 13 | 700-800 | gms | 13.9 | 6.7 | None |
| E2 | x-hatch 8 | +950 gms | | 6.4 | 3.4 | None |
| | | (tore sample) | | | | |
| E3 | x-hatch 8 | <10 | gms | 4.3 | 1.7 | None |

*x-hatch 13 = Crosshatch tooling pattern with 13 um valleys, x-hatch 8 is same but with 8 um valleys

### Liner Release Measurements

A Lab Master Release & Adhesion Tester (version 1.6.0) was used to measure the liner release from the samples created. This method evaluated Example E4. E4 was conditioned in a controlled humidity (around 50%) and temperature (around 73° F.) environment for 24 hours prior to testing. This test measured the release force of the adhesive from the liner at a 90-degree angle and a 180-degree angle. A piece of 3M 9425 Removable Double-Sided Tape was applied to the sled using a P.A.-1 3M squeegee. Each sample was then applied to the masking tape on the sled using a P.A.-1 3M squeegee. The squeegee wiped the sample back and forth three times to promote adhesion to the sled.

For the 90-degree angle, the sample was pulled using a sled speed of 255 in/min. The adhesive coated film was pulled from the liner. Samples were cut to 1″×15″ (CD×MD). Test values were recorded as grams/inch. The average was taken from three replicates and reported in table 3 below.

For the 180-degree angle, the sample was pulled using a sled speed of 90 in/min. The liner was pulled from the adhesive coated film. Samples were cut to 1″×15″ (CD×MD). Test values were recorded as grams/inch. The average was taken from three replicates and reported in Table 3 below.

ASTM D3330/D3330M-04 (Test method D-adhesion to Liner) was referenced.

TABLE 3
Liner release results

| Sample | Angle Peeled (degrees) | Release Force (g/in) |
|---|---|---|
| White sample E4 | 180 | 16.7 |
| White sample E4 | 90 | 38.3 |

For E4 peeled at 180 degrees, the release force was around 16.7 g/in. A release force of 16.7 g/in. For E4 peeled at 90 degrees, the release force was around 38.3 g/in. The resulting release forces are excellent for graphic film applications.

Thus, various embodiments of ADHESIVE ARTICLE WITH RECYCLABLE OR COMPOSTABLE RELEASE LINER are disclosed. Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g. 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The term “or” is generally employed in its inclusive sense, for example, to mean “and/or” unless the context clearly dictates otherwise. The term “and/or” means one or all of the listed elements or a combination of at least two of the listed elements.

What is claimed is:

1. An adhesive article attachable to a substrate, the article comprising:
an adhesive layer attachable to a major surface of a substrate; and
a releasable liner in contact with the adhesive layer, the releasable liner comprising a release layer and a biodegradable polymer layer applied to the release layer, wherein the release layer defines a structured surface in contact with the adhesive layer.

2. The article of claim 1, wherein the biodegradable polymer layer is compostable.

3. The article of claim 1, wherein the biodegradable polymer layer comprises raised features defining the structured surface of the release layer.

4. The article of claim 1, wherein the release layer is formed of a non-biodegradable material.

5. The article of claim 4, wherein the release layer comprises silicone.

6. The article of claim 4, wherein a ratio of a weight of the release layer to a total weight of the releasable liner is less than 15%.

7. The article of claim 4, wherein a ratio of a weight of the release layer to a total weight of the releasable liner is less than 1%.

8. The article of claim 1, wherein the biodegradable polymer layer comprises polybutylene succinate.

9. The article of claim 8, wherein the biodegradable polymer layer comprises a plant-based wax.

10. The article of claim 1, wherein the releasable liner further comprises a paper layer applied to the biodegradable polymer layer.

11. The article of claim 10, wherein the releasable liner further comprises another biodegradable polymer layer applied to an opposite side of the paper layer than the biodegradable polymer layer.

12. The article of claim 1, further comprising the substrate attached to the adhesive layer.

13. The article of claim 12, wherein the substrate comprises at least one of PVC, PET, PLA.

14. The article of claim 12, further comprising an ink layer on another major surface of the substrate opposite the adhesive layer.

15. The article of claim 1, wherein an average peel force between the adhesive layer and the releasable liner is less than 135 grams of force.

16. A method of forming an adhesive article, the method comprising:
providing an adhesive layer; and
laminating a releasable liner to the adhesive layer, the releasable liner comprising a release layer and a biodegradable polymer layer applied to the release layer, wherein the release layer defining a structured surface in contact with the adhesive layer.

17. The method of claim 16, further comprising:
coating the release layer onto the biodegradable polymer layer; and
embossing the release layer and biodegradable polymer layer to provide the releasable liner.

18. The method of using an adhesive article, the method comprising:
providing the adhesive article, wherein the adhesive article comprises a releasable liner in contact with an adhesive layer, the releasable liner comprising a release layer and a biodegradable polymer layer applied to the release layer, wherein the release layer defines a structured surface in contact with the adhesive layer,
removing the releasable liner from the adhesive layer; and
laminating the adhesive layer onto a surface of an object.
